(19) United States
(12) Patent Application Publication
(10) Pub. No.: US 2004/0230609 A1
(43) Pub. Date: Nov. 18, 2004

(54) Menu generation plan

(76) Inventor: Sarah May Watson, (US)

Correspondence Address: BURNS DOANE SWECKER & MATHIS L L P, POST OFFICE BOX 1404, ALEXANDRIA, VA, 22313-1404, US

(21) Appl. No.: 10/467,854

(22) PCT Filed: Feb. 13, 2002
(86) PCT No.: PCT/GB02/00643

(30) Foreign Application Priority Data
Feb. 14, 2001 (GB) 0103615.1

(51) Int. Cl. G06F 7/00

(52) U.S. Cl. 707/104.1

(57) ABSTRACT

A method of providing a varied sequence of items, e.g. a varied diet, involves determining constraints and establishing a parameter target value. This informaiton is then used to populate a two dimensional grid representing items in varied arrangement.

### FIELD OF THE INVENTION

The present invention relates to menu plan generation.

### BACKGROUND TO THE INVENTION

People have constraints upon the food that they may eat if they are to remain healthy or, for instance, lose weight, both in qualitative and quantitative terms. For instance, persons wishing to lose weight restrict their calorie intake whereas coeliacs disease sufferers must avoid gluten. These people face the problem of obtaining a diet that is not monotonous but which meets their dietary constraints. The provision of a varied diet assists a person in adhering to their dietary regime resulting in an improvement in the effectiveness of the diet, for instance achieving body size reduction more quickly.

### SUMMARY OF THE INVENTION

It is an aim of the present invention to provide a system for providing varied sequences of items. For example, a system whereby people having dietary constraints can be provided with a varied diet.

According to the present invention, there is provided a method of providing a varied array of items, the method comprising: —

creating a database of item definitions, each item definition including a value for a predetermined parameter;

determining a set of constraints, including a target value for said predetermined parameter; and

selecting item definitions from the database in dependence on said set of constraints to produce an array, having at least two dimensions of a predetermined number of item identifiers, in a manner adapted to produce variety in said array.

Preferably, the set of constraints is determined by receiving the results of a questionnaire, validating the results of the questionnaire and storing constraints derived from said results in association with said person. More preferably, said questionnaire comprises a hypermedia document form and is received in an http request.

Preferably, the method includes transmitting said array of item identifiers by email.

Preferably, said selection of items comprises populating a template data structure, representing a grid having a rows and a columns, with values such that the total of the values for each column equals said target value. More preferably, the values for each row of one column are selected randomly from a set of predetermined value distributions, the value total for each member of the set being the same. Yet more preferably, said selection of item identifiers comprises populating an item data structure, representing a grid having rows and columns, with item identifiers wherein each item identifier identifies an item having the parameter value in the corresponding element of said template data structure. Still mote preferably, the method comprises generating a data set of identifiers of acceptable items by retrieving identifiers for items meeting said constraints from said database, wherein the item data structure is populated from said data set.

According to the present invention, there is provided a method of providing a varied diet, the method comprising: —

creating a database of meal definitions, each meal definition including a value for a nutritional parameter;

determining a set of dietary constraints affecting a person, including a target value for said nutritional parameter;

selecting meal definitions from the database in dependence on said set of dietary constraints to produce a menu plan for said person for a predetermined number of days in a manner adapted to produce variety in said menu plan; and

transmitting the menu plan.

According to the present invention, there is also provided a method of reducing the size or weight of a person, the method comprising:

creating a database of meal definitions, each meal definition including a value for a nutritional parameter;

determining a target value for said nutritional parameter in dependence on measured physical characteristics of a person;

selecting meal definitions from the database in dependence on said target value to produce a menu plan for said person for a predetermined number of days in a manner adapted to produce variety in said menu plan;

transmitting the menu plan to said person; and

ingestion of foodstuffs by said person in accordance with said menu plan so as to effect a reduction in the size or weight thereof.

It will be appreciated that the degree of variety achievable in the menu plan will be a function of the size of the database and the dietary constraints imposed.

Preferably, there is a random aspect to the selection of the meal definitions. However, a more deterministic, e.g. cyclic, selection scheme could be employed to ensure variety.

Preferably, the size or weight reducing method includes selecting said meal definitions in dependence on an additional dietary constraint, said target value and said additional dietary constraint being members of a set of dietary constraints for said person.

Preferably, said target value is determined by weighing and measuring the height of the person to whom the varied diet is to be provided.

Preferably, the set of dietary constraints is determined by receiving the results of a questionnaire for a person, validating the results of the questionnaire and storing dietary constraints derived from said results in association with said person. More preferably, said questionnaire comprises a hypermedia document form and is received in an http request.

Preferably, said menu plan is transmitted by email.

Preferably, said selection of meal definitions comprises populating a template data structure, representing a grid having days along one axis and meals along another axis, with nutritional values for meals such that the total of the nutritional values for each day equals said target value.

Preferably, the nutritional values for the meals of one day are selected randomly from a set of nutritional value distributions, the nutritional value total for each member of the set being the same.

Preferably, said selection of meal definitions comprises populating a meal data structure, representing a grid having days along one axis and meals along another axis, with meal identifiers wherein each meal identifier identifies a meal having the nutritional parameter value in the corresponding element of said template data structure.

Preferably, a data set of identifiers of acceptable meals is generated by retrieving identifiers for meals meeting said constraints from said database and the meal data structure is populated from said data set.

According to the present invention, there is provided a process for reducing the body weight of a person comprising:

(a) defining a plurality of candidate meals including lunches and dinners;

(b) calculating a single numerical value for each candidate meal, the single numerical value being dependent on at least the caloric and fat content of each such meal;

(c) calculating a target numerical value allotted per day for the person based on at least the person's current body weight and desired weight loss;

(d) selecting meals from the plurality of candidate meals to produce a menu plan for the person for a predetermined number of days, such that the total of the numerical values for the meals selected for each day is less than or equal to the target numerical value and such that a variety of meals are included in the menu plan;

(e) ingesting the meals from the menu plan; and

(f) repeating at least step (e) until the desired weight loss is achieved.

Preferably, the process further comprises the person selecting certain food items which must be included in the meals of the menu plan and employing a programmable computer to produce a menu plan in conformance with these selections.

Preferably, the process further comprises the person designating at least some of the candidate meals as “eating out,” “ready” and “recipe meals” and employing a programmable computer to produce a menu plan in conformance with these selections.

According to the present invention, there is provided data processing system for providing a multi-day menu plan for a person to assist the person in body weight reduction comprising:

data storage means for storing candidate meal definitions and numerical values associated with each candidate meal dependent on at least the caloric and fat content of each such candidate meal;

data server means for obtaining information from the person over the internet including weight information and food preferences and for transmitting the menu plan back to the person; and

data processing means for calculating a target daily numerical value for the person based on at least the person's current body weight, and for selecting meals from the plurality of candidate meals to produce a multi-day menu plan such that the total of the numerical values for the meals selected for each day is less than or equal to the target numerical value, such that a variety of meals are included in the menu plan, and such that the food preferences obtained from the person are included in the menu plan.

It will be appreciated that where the present invention is applied to slimming, the slimming may be non-therapeutic.

### BRIEF DESCRIPTION OF THE DRAWINGS

FIG. 1 is a data flow diagram illustrating a system according to the present invention;

FIG. 2 is a diagram illustrating a web server and a computer for generating menu plans;

FIG. 3 is a flowchart illustrating a menu plan preparation program;

FIG. 4 illustrates a table of valid daily nutritional parameter distributions;

FIG. 5 illustrates a nutritional parameter template grid;

FIG. 6 illustrates a menu grid;

FIG. 7 is a more detailed flowchart of step s7 of FIG. 3;

FIG. 8 is a more detailed flowchart of step s8 of FIG. 3;

FIG. 9 is a more detailed flowchart of step s9 of FIG. 3;

FIG. 10 is a more detailed flowchart of step s10 of FIG. 3;

FIG. 11 is a more detailed flowchart of step s14 of FIG. 3;

FIG. 12 is a more detailed flowchart of step s16 of FIG. 3; and

FIG. 13 is a more detailed flowchart of step s18 of FIG. 3.

### DETAILED DESCRIPTION OF THE PREFERRED EMBODIMENT

An embodiment of the present invention will now be described, by way of example, with reference to the accompanying drawings.

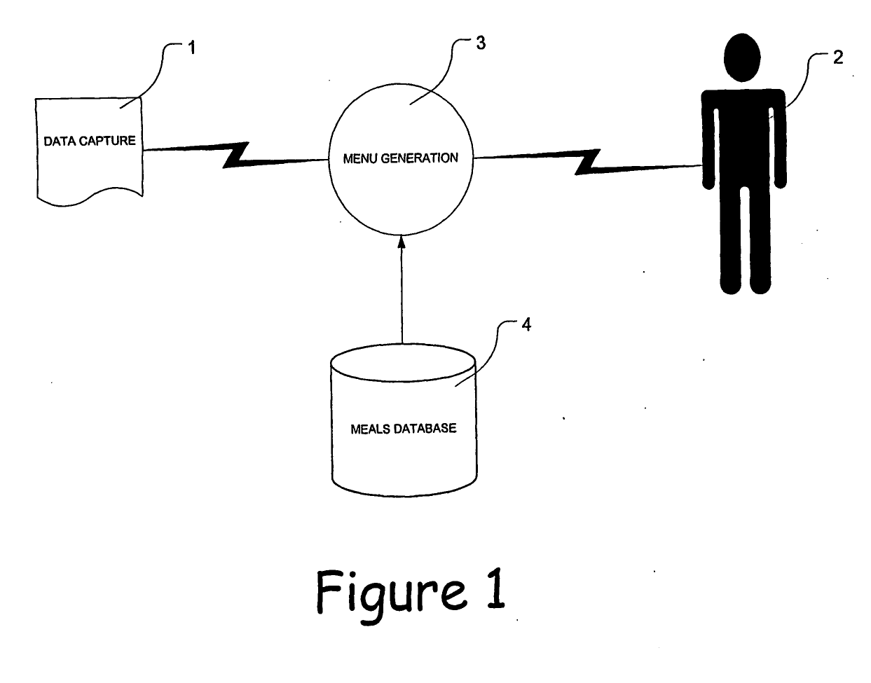

Referring to FIG. 1, a system according to the present invention employs a data capture stage 1 for capturing information relating to the dietary constraints of a person 2. The captured data is transmitted to a menu plan generation stage 3 which generates a set of meal definitions for a predetermined period, e.g. a fortnight, in dependence on the captured data using a database of meals 4. The resultant set of meal definitions is then communicated to the person 2.

The capture stage 1 may comprise machine reading of a paper questionnaire and the resultant set of meal definitions communicated to the person 2 as a printed document.

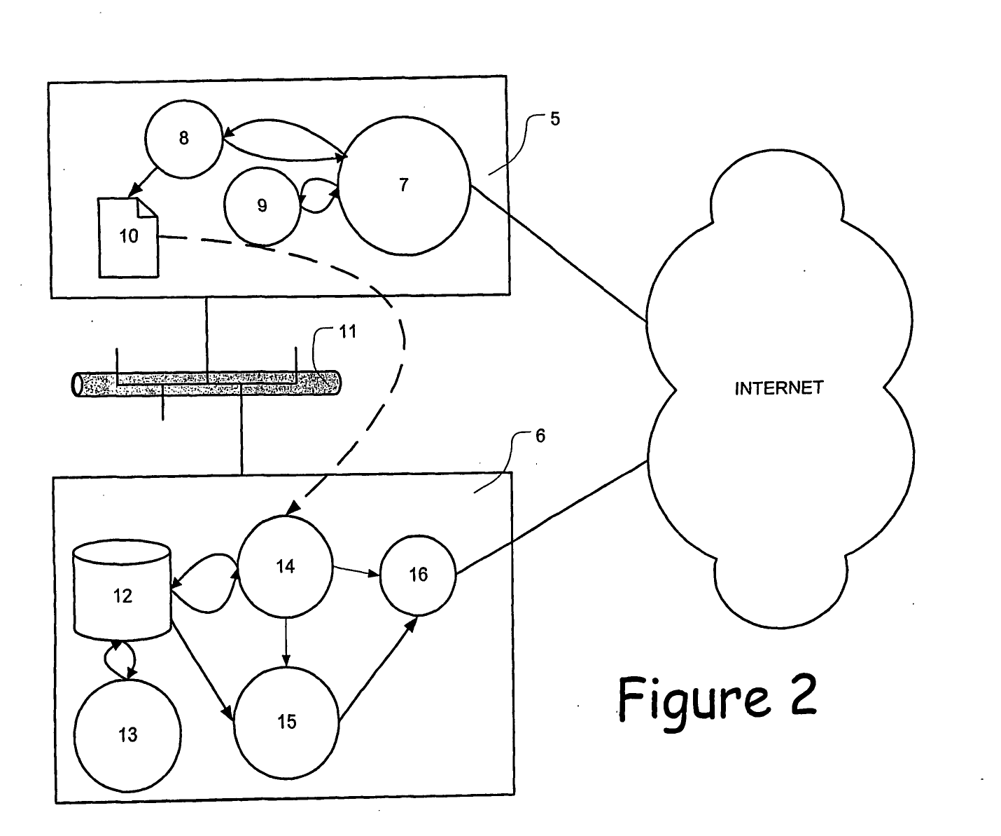

Referring to FIG. 2, the data capture stage 1 is effected by a web server machine 5 and the menu plan generation stage 3 is performed by a dedicated computer 6.

The web server machine 5 has a web server process 7 running on it. First and second CGI (Common Gateway Interface) programs 8, 9 can be run by the web server process 7 for processing the contents of, respectively, a questionnaire form web page and a “member” login form page.

The questionnaire form web page is provided so that people can become members and asks for the following information:—

given and family names;

title;

address, including postal code;

e-mail address;

telephone number;

sex;

date of birth;

height; and

current weight.

credit card details.

The people filling in the form will have weighed themselves and measured their heights.

Additionally, the questionnaire form includes checkboxes and radio buttons so that the prospective member can answer the following questions:—

Are they?—

diabetic;

vegetarian;

Jewish requiring kosher food;

Muslim requiring halal food.

Do they suffer from coeliac disease?

Do they have any of the following allergies?—

nut allergy;

wheat allergy;

dairy allergy.

Do they prefer?—

no milk;

skimmed milk;

semi-skimmed milk.

Do they prefer?—

low fat spread;

margarine high in polyunsaturated fats;

butter.

Would they prefer to avoid?—

alcohol;

red meat;

fish.

and select three items from:—

chocolate;

cheese;

crisps (US: chips);

biscuits (US cookies);

bread;

wine;

beer;

spirits;

chips (US: french fries); and

ice cream

as “must have” items.

The questionnaire form also allows the prospective member to enter:—

the number of times (0, 1-2, 3-5, 6-9, 10-14) that they would like to eat out (“eating out” meals) during a fortnight and the types of food they would like to each on such occasions (burgers, curries, grills, jacket potatoes, pizzas, roast dinners. salads, sandwiches, stir-frys);

the number of times that they wish to cook main meals (“recipe” meals) during a fortnight (0, 1-2, 3-5, 6-9, 10-14) and for how many people;

the number of heat-only prepared main meals (“ready” meals) that they would like during a fortnight (0, 1-2, 3-5, 6-9, 10-14).

Finally, many people like to start each day with the same breakfast and the questionnaire form allows the prospective member to indicate this and choose the type of breakfast required (toast and marmalade, cereal, cereal and toast, cooked).

When the form is submitted by a person becoming a member, the first CGI program 8 validates the data and, if it appears valid, e.g. wine as a “must have” does not conflict with a desire to avoid alcohol, stores it in a respective file 10 in an XML format.

The “member” login form page includes boxes for the member to enter their unique username and password. When the “member” login form is submitted by a member, the second CGI program 9 validates the username and password and, if they are correct, stores the unique username in a respective file 10.

The web server machine 5 is connected to a menu plan generation machine 6 by a local area network 11.

The menu plan generation machine 6 supports a database 12, a configuration program 13, a web server interface program 14, a menu plan generation program 15 and an e-mail program 16.

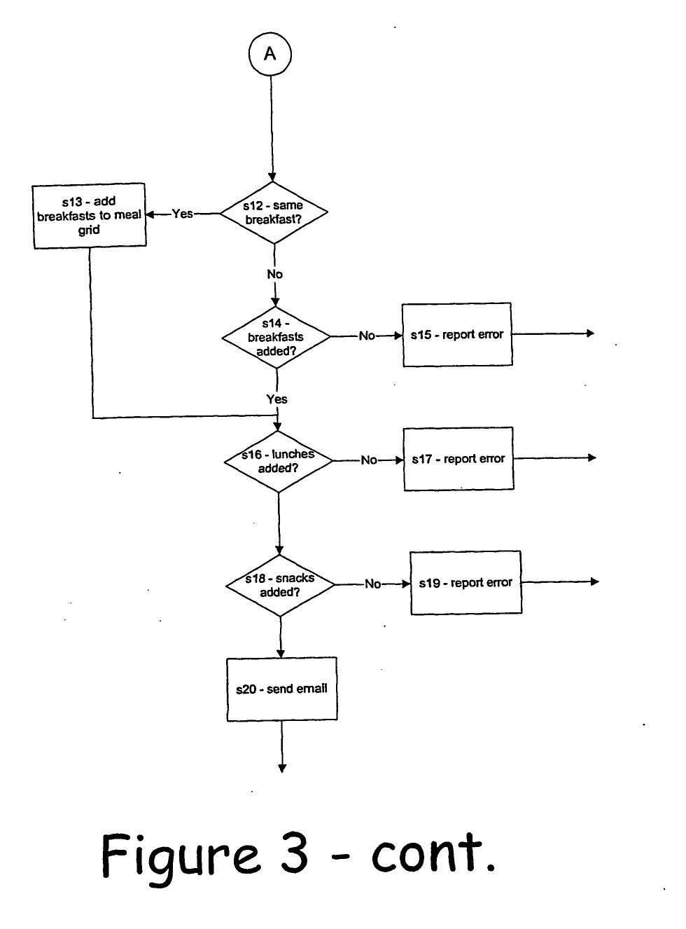

The database 12 comprises tables containing member details, meal definitions and a points distribution table 20 (FIG. 4). These points are allocated to food items on the basis of nutritional parameters determined by measurement and analysis of the food items, in this case the calorie and fat content of the food (See EP-A-0859981). The points distribution table 20 contains a plurality of distributions, i.e. allocations of points to breakfast, lunch, evening meal, snack and milk, for each of a range of daily points targets.

Meal definitions are loaded into the database 12 by means of the configuration program 13 which provides an administration user interface. The meal definitions include fields identifying main ingredients types, e.g. fish, red meat, chicken, and the types of diet, e.g. halal, vegetarian, nut-free, for which they are suitable, whether they are generally applicable and the points value. Some restricted diet items, e.g. gluten-free biscuits, are not appropriate for people not requiring a gluten-free diet. However, others, such as Spaghetti Neapolitano, are specifically suitable for vegetarians but are also more widely suitable.

The web server interface program 14 periodically reads the contents of the files 10.

If a file 9 contains full user details, the web server interface program 14 stores the user details in the database 12 and generates a username and initial password. The username and initial password are sent to the web server machine 5 which sends them to the new member in an HTML page and stores them for subsequent validation of logins by the member.

If the file 10 contains only a username, the web server interface program 14 passes the username to the menu plan generation program 15.

The menu plan generation program 15 obtains the member's details from the database 12 using the username and then generates a menu plan for a fortnight on the basis of the member's details and the time of year or festivals, e.g. Christmas or Shrove Tuesday, occurring during the period for which the menu plan is being generated. The completed menu plan is sent to the requesting member in an e-mail by means of the e-mail program 16.

When the web server interface program 14 stores new member's details in the database 12, it allocates a points target to the new member on the basis of their BMI (Basal Metabolic Rate) and their activity level. The BMI is determined from the member's height, weight, age and sex. For example, a person allocated 22 points may eat food whose “points” values add up. to 22 points in any one day. This value will need to be recalculated as the member reports back weight or activity level changes.

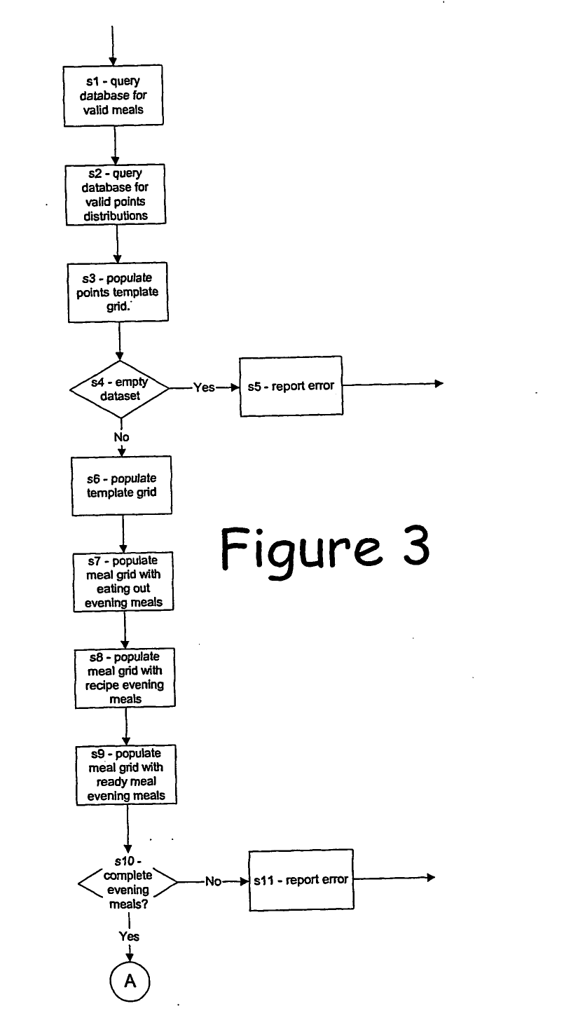

Referring to FIG. 3, when a menu plan is to be generated for a member, the menu plan generation program 15 queries the database 12 to obtain a valid meal data set containing all of the meal definitions which are appropriate for the member, according to the questionnaire answers given by the member and the current season (step S1).

A valid points distribution data set is then generated by querying the points distribution table 20 for records for the appropriate total points, the appropriate “milk” point and the appropriate breakfast points, if the member has specified that the same breakfast is required every day (step s2). If the result is an empty set, e.g. because there are no suitable breakfasts, an error is reported (step s5) and the process terminates.

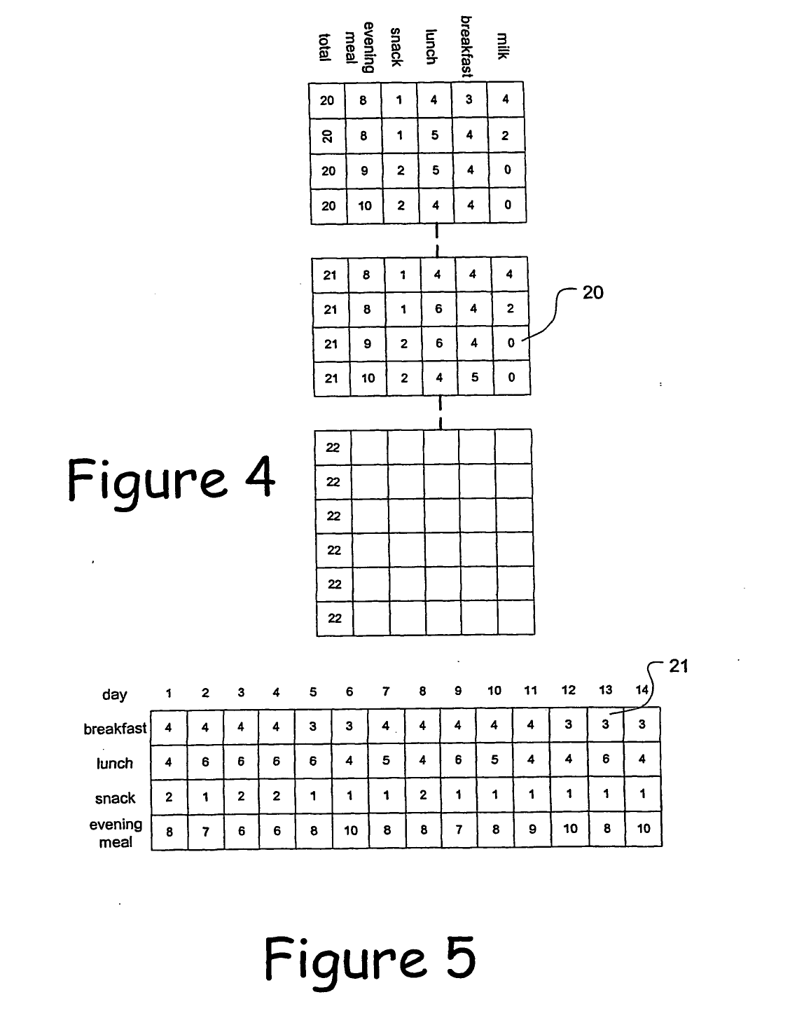

Referring to FIG. 5, a 14×4 points template grid 21, i.e. 14 days by breakfast, lunch, evening meal, and snacks is populated randomly from the rows returned in step s2 (step s6).

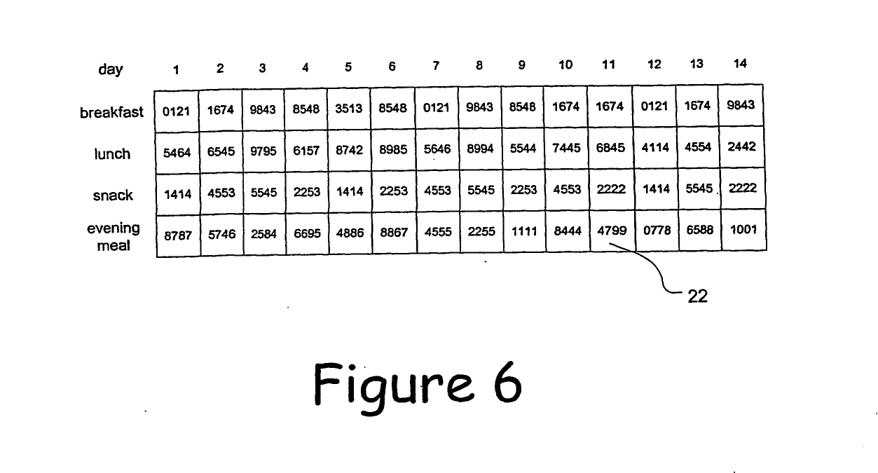

Once the template grid 21 has been populated, a 14×4 menu grid 22 (FIG. 6) is populated with meal ids using the points template grid 21 as a guide.

The first stage of this process is to attempt to meet the member's requirements for “eating out” evening meals (step s7).

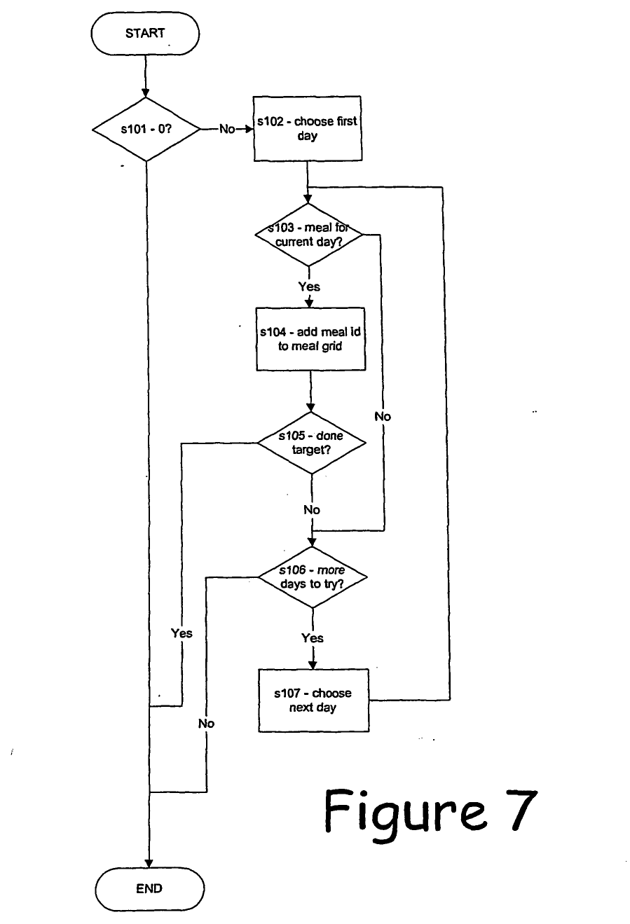

Referring to FIG. 7, it is first determined whether the member wishes to eat out at all (step s101). If not, the process terminates. However, if the member does want to eat out, a first day is chosen according to the maximum (2, 5, 9, 14) of the range selected by the member for “eating out” meals and a predetermined algorithm (step s102). Then any suitable meals are extracted from the data set obtained at step s1 and placed in a random order. A suitable meal here will be one with the points value specified in the corresponding location of the points template grid 21. The list is then searched from the top to the bottom for a meal that has not already been picked and which has a different main ingredient to those on the preceding and succeeding days, if any. If a meal is found (step s103), its id is added to the menu grid 22 in the appropriate location (step s104). It is then determined whether the maximum of member's desired range for “eating out” meals has been reached (step s105). If so, the process terminates, otherwise it is determined whether there are any mote days to which an “eating out” evening meal could be allocated (step s106). If not, the process terminates, otherwise the next day is selected according to the aforementioned algorithm (step s107).

If a suitable meal is not found at step s103, the process moves directly to step s106.

Next, an attempt is made to meet the member's requirements for “recipe” meals, i.e. meals to be prepared for or by the member and which ate provided to the member with a recipe (step s8). The recipes may be for more than one person, for instance if the member's family members are all to have the meal.

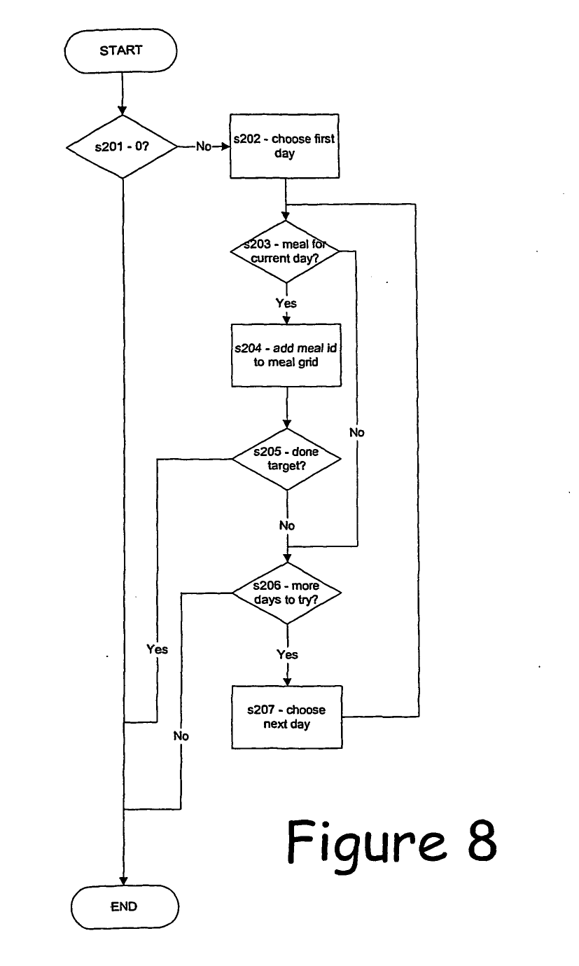

Referring to FIG. 8, it is first determined whether the member wishes to have any “recipe” meals (step s201). If not, the process terminates. However, if the member does want to have “recipe” meals, a first day is chosen according to the maximum (2, 5, 9, 14) of the range selected by the member for “recipe” meals and a predetermined algorithm (step s202). Then any suitable meals are extracted from the data set obtained at step S1 and placed in a random order. A suitable meal here will be one with the points value specified in the corresponding location of the points template grid 21. The list is then searched from the top to the bottom for a meal that has not already been picked and which has a different main ingredient to the main meals on the preceding and succeeding days, if any. If a meal is found (step s203), its id is added to the menu grid 22 in the appropriate location (step s204). It is then determined whether the maximum of member's desired range for “recipe” meals has been reached (step s205). If so, the process terminates, otherwise it is determined whether there are any more days to which an “recipe” evening meal could be allocated (step s206). If not, the process terminates, otherwise the next day is selected according to the aforementioned algorithm (step s207).

If a suitable meal is not found at step s203, the process moves directly to step s206.

After the recipe meals have been added, an attempt is made to meet the member's requirements for ready meals, i.e. meals that simply need to be reheated (step s9).

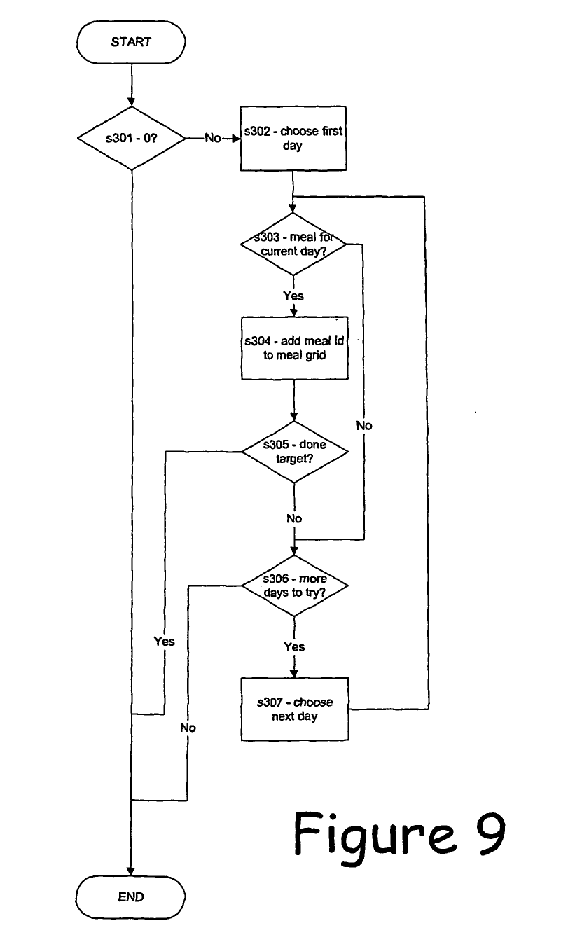

Referring to FIG. 9, it is first determined whether the member wishes to any “ready” meals (step s301). If not, the process terminates. However, if the member does want “ready” meals, a first day is chosen according to the maximum (2, 5, 9, 14) of the range selected by the member for “ready” meals and a predetermined algorithm (step s302). Then any suitable meals are extracted from the data set obtained at step S1 and placed in a random order. A suitable meal here will be one with the points value specified in the corresponding location of the points template grid 21. The list is then searched from the top to the bottom for a meal that has not already been picked and which has a different main ingredient to the main meals on the preceding and succeeding days, if any. If a meal is found (step s303), its id is added to the menu grid 22 in the appropriate location (step s304). It is then determined whether the maximum of the member's desired range for “ready” meals has been reached (step s305). If so, the process terminates, otherwise it is determined whether there ate any more days to which an “ready” evening meal could be allocated (step s306). If not, the process terminates, otherwise the next day is selected according to the aforementioned algorithm (step s307).

If a suitable meal is not found at step s303, the process moves directly to step s306.

Any remaining gaps for evening meals in the menu grid 22 are then filled with meals which are not specifically “eating out”, “recipe” or “ready” meals (step s10).

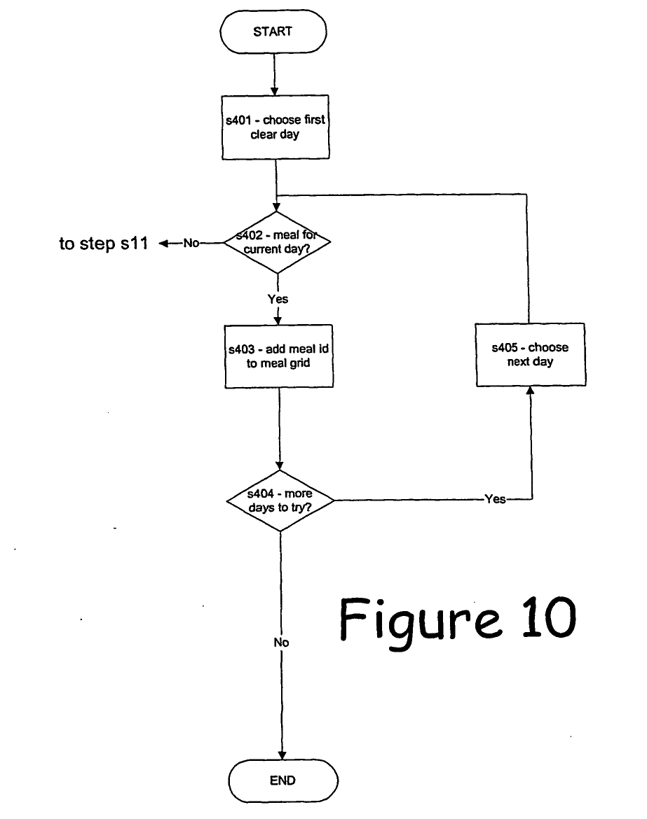

Referring to FIG. 10, the first day without an evening meal allocated to it is selected first (step s401). Then any suitable meals are extracted from the data set obtained at step s1 and placed in a random order. A suitable meal here will be one with the points value specified in the corresponding location of the points template grid 21. The list is then searched from the top to the bottom for a meal that has not already been picked and which has a different main ingredient to the main meals on the preceding and succeeding days, if any. If a meal is found (step s402), its id is added to the menu grid 22 in the appropriate location (step s403), otherwise an error is reported (step s11 in FIG. 3) and the menu plan generation process terminates. If a meal has been added at step s403, it is determined whether there are any more days to which an evening meal needs to allocated (step s404). If not, the process terminates, otherwise the next day is selected according to the aforementioned algorithm (step s405).

If the member has specified that they want the same breakfast each day (step s12), the breakfast elements the menu grid 22 are populated with the relevant meal type (step s13). If the member has not specified that they want the same breakfast each day (step s12), the breakfast elements of the menu grid 22 are populated with breakfasts with the appropriate points values (step s14).

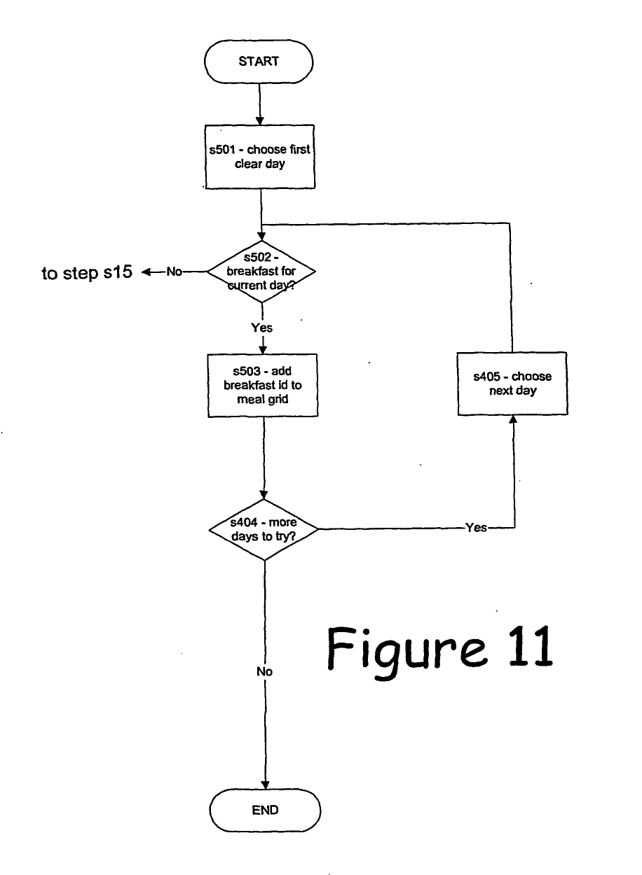

Referring to FIG. 11, the first day is selected first (step s501). Then any suitable breakfasts are extracted from the data set obtained at step s1 and one is selected at random. A suitable breakfast here will be one with the points value specified in the corresponding location of the points template grid. If the range of available breakfasts is sufficiently large, a different breakfast is preferably selected for each day, as in the case of the main meals. If a breakfast is found (step s502), its id is added to the menu grid 22 in the appropriate location (step s503), otherwise an error is reported (step s15 in FIG. 3) and the menu plan generation process terminates. If a breakfast has been added at step s503, it is determined whether there are any more days to which a breakfast needs to be allocated (step s404). If not, the process terminates, otherwise the next day is selected according to the aforementioned algorithm (step s505).

After the breakfasts have been dealt with, the lunch elements of the menu grid 22 are filled randomly with meals with the appropriate points value whilst avoiding the situation where the lunch and evening meal of a day have the same main ingredient (step s16).

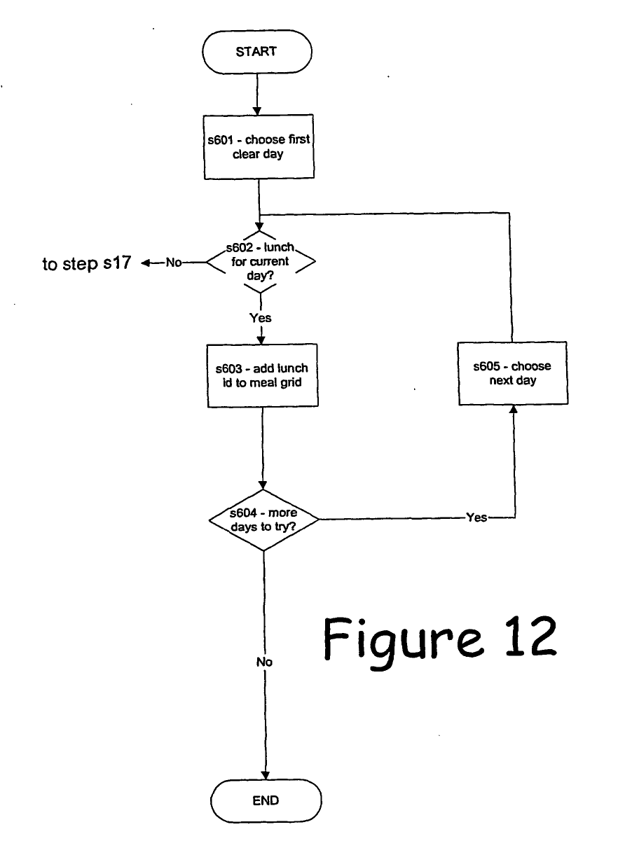

Referring to FIG. 12, the first day is selected first (step s601). Then any suitable lunches are extracted from the data set obtained at step S1 and placed in a random order. A suitable lunch here will be one with the points value specified in the corresponding location of the points template grid 21. After randomisation, the list is sorted so that lunches with the same main ingredient as the evening meal for the day are moved to the bottom of the list. The lunch at the top of the list is selected if it does not have the same main ingredient for the main meal of the same day. If a suitable lunch is found (step s602), its id is added to the menu grid 22 in the appropriate location (step s603), otherwise an error is reported (step s17 in FIG. 3) and the menu plan generation process terminates. If a lunch has been added at step s603, it is determined whether there are any more days to which a lunch needs to be allocated (step s604). If not, the process terminates, otherwise the next day is selected according to the aforementioned algorithm (step s605).

Finally, the snack elements of the menu grid 22 are filled randomly with meals with the appropriate points value (step s18).

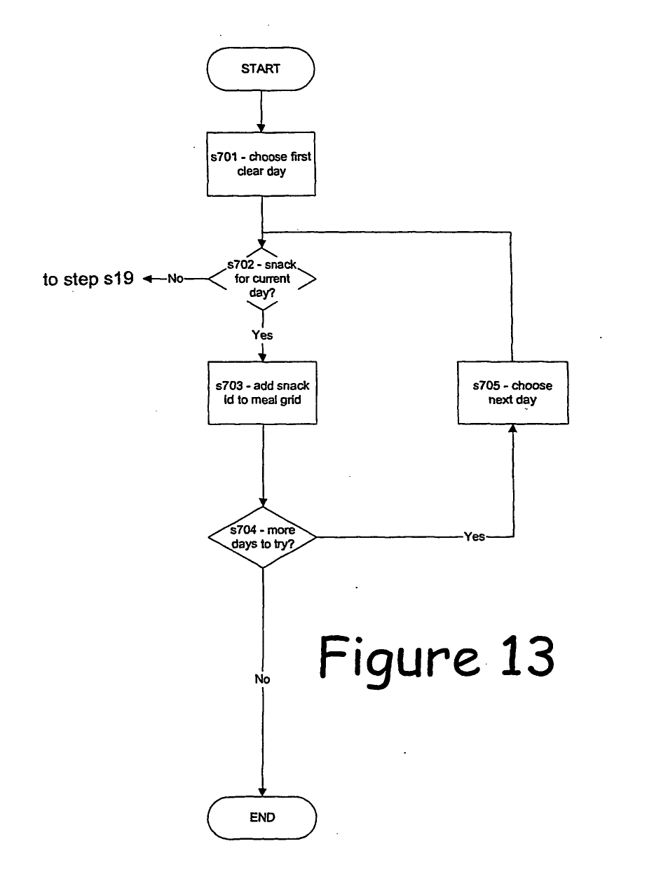

Referring to FIG. 13, the first day is selected first (step s701). Then any suitable snacks are extracted from the data set obtained at step s1 and one is selected at random. A suitable snack here will be one with the points value specified in the corresponding location of the points template grid. If a suitable range of snacks are available, a different snack is selected for each day such that no day has a snack and a main meal with the same main ingredient. If a suitable snack is found (step s702), its id is added to the menu grid 22 in the appropriate location (step s703), otherwise an error is reported (step s19 in FIG. 3) and the menu plan generation process terminates. If a snack has been added at step s703, it is determined whether there are any more days to which a snack needs to be allocated (step s704). If not, the process terminates, otherwise the next day is selected according to the aforementioned algorithm (step s705).

In each of steps s7, s8, s9, s10, s14, s16 and s18, the meals are randomly chosen from the relevant subset of the valid means data set. However, a weighting is applied to meals according to whether they contain a “must have” item which the member has specified. Consequently, meals including “must have” items are more likely to be selected.

When a menu plan has been successfully generated, a email containing the menu plan, including any recipes for “recipe” meals and any milk items, which are constant across the period of the menu plan, is generated and sent to the member using the email program 16 (step s20).

On receiving the email, the member eats the meals specified therein over the two-week period covered by it and achieves a weight loss thereby.

It will be appreciated that many modifications can be made to the embodiment described above. For example, the menu plan could be presented to the member as a web page or as a printed document.

In another embodiment, menu plan generating program 15 produces one or more grocery order messages, in dependence on the menu plan and information in the database 12, and sends them to respective stores. Stores receiving these messages make up the orders and send them to the member who requested the menu plan on which the orders were based.

By limiting the grids to one day, the present invention can be employed to provide ad hoc menu plan suggestions for one day. For instance, a member would request a web page with a button labelled, for example, “What shall I eat today” and radio buttons for selecting “eat out”, “recipe”, “ready” or “any” for the evening meal. Clicking on the button would cause a CGI program to populate a one-day menu grid, using a method substantially as described above but with the radio button selections overriding any preference for evening meal types in the database 12, and present the result to the user as a web page.

Alternatively, the menu plans could be produced cyclically, e.g. fortnightly, for a member and stored rather than being sent in one transmission. The user would then request the current day's menu plan using a web browser.

1. A method of providing a varied array of items, the method comprising:
creating a database of item definitions, each item definition including a value for a predetermined parameter;
determining a set of constraints, including a target value for said predetermined parameter; and
selecting item definitions from the database in dependence on said set of constraints to produce an array, having at least two dimensions of a predetermined number of item identifiers, in a manner adapted to produce variety in said array.

2. A method according to claim 1, wherein the set of constraints is determined by receiving the results of a questionnaire, validating the results of the questionnaire and storing constraints derived from said results in association with said person.

3. A method according to claim 2, wherein said questionnaire comprises a hypermedia document form and is received in an http request.

4. A method according to claim 1 including transmitting said array of item identifiers by email.

5. A method according to claim 1, wherein said selection of items comprises populating a template data structure, representing a grid having a rows and a columns, with values such that the total of the values for each column equals said target value.

6. A method according to claim 5, wherein the values for each row of one column are selected randomly from a set of predetermined value distributions, the value total for each member of the set being the same.

7. A method according to claim 5, wherein said selection of item identifiers comprises populating an item data structure, representing a grid having rows and columns, with item identifiers wherein each item identifier identifies an item having the parameter value in the corresponding element of said template data structure.

8. A method according to claim 7, comprising generating a data set of identifiers of acceptable items by retrieving identifiers for items meeting said constraints from said database, wherein the item data structure is populated from said data set.

9. A method of providing a varied diet, the method comprising: —
creating a database of meal definitions, each meal definition including a value for a nutritional parameter;
determining a set of dietary constraints affecting a person, including a target value for said nutritional parameter;
selecting meal definitions from the database in dependence on said set of dietary constraints to produce a menu plan for said person for a predetermined number of days in a manner adapted to produce variety in said menu plan; and
transmitting the menu plan.

10. A method according to claim 9, wherein said target value is determined by weighing and measuring the height of the person to whom the varied diet is to be provided.

11. A method according to claim 9, wherein the set of dietary constraints is determined by receiving the results of a questionnaire for a person, validating the results of the questionnaire and storing dietary constraints derived from said results in association with said person.

12. A method according to claim 11, wherein said questionnaire comprises a hypermedia document form and is received in an http request.

13. A method according to claim 9, wherein the menu plan is transmitted by email.

14. A method according to claim 9, wherein said selection of meal definitions comprises populating a template data structure, representing a grid having days along one axis and meals along another axis, with nutritional values for meals such that the total of the nutritional values for each day equals said target value.

15. A method according to claim 14, wherein the nutritional values for the meals of one day are selected randomly from a set of nutritional value distributions, the nutritional value total for each member of the set being the same.

16. A method according to claim 14, wherein said selection of meal definitions comprises populating a meal data structure, representing a grid having days along one axis and meals along another axis, with meal identifiers wherein each meal identifier identifies a meal having the nutritional parameter value in the corresponding element of said template data structure.

17. A method according to claim 16, comprising generating a data set of identifiers of acceptable meals by retrieving identifiers for meals meeting said constraints from said database, wherein the meal data structure is populated from said data set.

18. A method of reducing the size or weight of a person, the method comprising:
creating a database of meal definitions, each meal definition including a value for a nutritional parameter;
determining a target value for said nutritional parameter in dependence on measured physical characteristics of a person;
selecting meal definitions from the database in dependence on said target value to produce a menu plan for said person for a predetermined number of days;
transmitting the menu plan to said person in a manner adapted to produce variety in said menu plan; and
ingestion of foodstuffs by said person in accordance with said menu plan so as to effect a reduction in the size or weight thereof.

19. A method according to claim 18, wherein said target value is determined by weighing and measuring the height of the person to whom the varied diet is to be provided.

20. A method according to claim 18, including selecting said meal definitions in dependence on an additional dietary constraint, said target value and said additional dietary constraint being members of a set of dietary constraints for said person.

21. A method according to claim 20, wherein the set of dietary constraints is determined by a process including receiving the results of a questionnaire for said person, validating the results of the questionnaire and storing the dietary constraints derived from said results in association with said person.

22. A method according to claim 21, wherein said questionnaire comprises a hypermedia document form and is received in an http request.

23. A method according to claim 18, wherein the menu plan is transmitted by email.

24. A method according to claim 18, wherein said selection of meal definitions comprises populating a template data structure, representing a grid having days along one axis and meals along another axis, with nutritional values for meals such that the total of the nutritional values for each day equals said target value.

25. A method according to claim 24, wherein the nutritional values for the meals of one day are selected randomly from a set of nutritional value distributions, the nutritional value total for each member of the set being the same.

26. A method according to claim 24, wherein said selection of meal definitions comprises populating a meal data structure, representing a grid having days along one axis and meals along another axis, with meal identifiers wherein each meal identifier identifies a meal having the nutritional parameter value in the corresponding element of said template data structure.

27. A method according to claim 26, comprising generating a data set of identifiers of acceptable meals by retrieving identifiers for meals meeting said constraints from said database, wherein the meal data structure is populated from said data set.

28. A process for reducing the body weight of a person comprising:
(a) defining a plurality of candidate meals including lunches and dinners;
(b) calculating a single numerical value for each candidate meal, the single numerical value being dependant on at least the caloric and fat content of each such meal;
(c) calculating a target numerical value allotted per day for the person based on at least the person's current body weight and desired weight loss;
(d) selecting meals from the plurality of candidate meals to produce a menu plan for the person for a predetermined number of days, such that the total of the numerical values for the meals selected for each day is less than or equal to the target numerical value and such that a variety of meals are included in the menu plan;
(e) ingesting the meals from the menu plan; and
(f) repeating at least step (e) until the desired weight loss is achieved.

29. The process of claim 28, further comprising the person selecting certain food items which must be included in the meals of the menu plan and employing a programmable computer to produce a menu plan in conformance with these selections.

30. The process of claim 28 further comprising the person designating at least some of the candidate meals as “eating out,” “ready” and “recipe meals” and employing a programmable computer to produce a menu plan in conformance with these selections.

31. A data processing system for providing a multi-day menu plan for a person to assist the person in body weight reduction comprising:
data storage means for storing candidate meal definitions and numerical values associated with each candidate meal dependent on at least the caloric and fat content of each such candidate meal;
data server means for obtaining information from the person over the internet including weight information and food preferences and for transmitting the menu plan back to the person; and
data processing means for calculating a target daily numerical value for the person based on at least the person's current body weight, and for selecting meals from the plurality of candidate meals to produce a multi-day menu plan such that the total of the numerical values for the meals selected for each day is less than or equal to the target numerical value, such that a variety of meals are included in the menu plan, and such that the food preferences obtained from the person are included in the menu plan.
